(19) United States
(12) Patent Application Publication
(10) Pub. No.: US 2002/0063794 A1
(43) Pub. Date: May 30, 2002

(54) High definition matrix display method for standard definition TV signals

(76) Inventor: Donald Henry Willis, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/008,484

(22) Filed: Nov. 5, 2001

Related U.S. Application Data
(60) Provisional application No. 60/250,181, filed on Nov. 30, 2000.

(51) Int. Cl. H04N 7/01; H04N 11/20

(52) U.S. Cl. 348/448; 348/445

(57) ABSTRACT

A method of displaying a standard definition television signal (20 and 30 or 40) on a high definition matrix display (10) includes the steps of receiving (22) the standard definition television signal to provide a received signal, sampling (24) the received signal to provide a sampled digital video signal, and deinterlacing (26) the sampled digital video signal to provide a progressive line signal. The method further includes the steps of doubling (34 or 42) the progressive line signal to provide a predetermined number of active lines of video in a frame) and displaying (34 or 46) the predetermined number of active lines of video on the high definition matrix display in a shortened vertical interval.

### CROSS REFERENCE TO RELATED APPLICATIONS

This is a non-provisional application which claims the benefit of provisional application serial No. 60/250,181, filed Nov. 30, 2000.

### FIELD OF THE INVENTION

The present invention relates to video signal processing, and more particularly to display of standard definition video on a high definition matrix display.

### BACKGROUND OF THE INVENTION

A 1920X1080 display utilized in a high definition television (HDTV) receiver should also be useable for standard definition video such as NTSC. A means is needed that will acceptably achieve this. In the past, HDTV sets were, and still are, CRT-based. For this type of display, the signal can be reformatted to the HDTV scan rates or the scan can be changed for the standard definition signal, or a combination of the two can be used. These last two methods are not available for matrix displays (e.g., liquid crystal or liquid crystal on silicon displays) and the reformatting scheme for HDTV scan rates may be too complicated and/or may degrade the picture in matrix displays.

The present invention is directed to facilitating the display of standard definition video on a matrix display utilized by a HDTV receiver without significantly degrading the picture in matrix displays.

### SUMMARY OF THE INVENTION

In a first embodiment of the present invention, a high definition matrix display or a 1080 line display, such as a liquid crystal display (LCD) or a liquid crystal on silicon (LCOS) display, is driven with a standard definition television signal (NTSC signal) by first deinterlacing the video and then placing the resulting progressive line signal (preferably in the form of 480 lines or a 480p signal) in a portion of the display by writing the signal into a memory. Each line of the progressive line signal is read twice from memory to produce a predetermined number of active lines of video (preferably in the form of a standard 960p signal). When the black lines at the top and bottom of the picture are transmitted, there is a shorter time to transmit the predetermined number of active lines to the display. In order to compensate for the reduced transmission time, the progressive line signal (480 active lines) are read out (twice) from the memory in a shorter time than was used to write the 480 active lines into the memory.

In an alternative embodiment of the present invention, a high definition matrix display or a 1080 line display, such as an LCD or LCOS display, is driven with an NTSC signal by first deinterlacing the video, then repeating each line, and then placing the resulting progressive line signal (preferably 960 active lines) in a portion of the display by writing the signal into a memory. When transmitting black lines at the top and bottom of the picture there is a shorter time to transmit the active lines to the display, so the active lines are read out of the memory in a shorter time than was used to write the active lines into the memory.

### BRIEF DESCRIPTION OF THE DRAWINGS

In the drawings:

FIG. 1 illustrates an exemplary 1920X1080 display;

FIG. 2 is a flow chart illustrating the initial steps of an NTSC video signal processing method in accordance with the present invention;

FIG. 3 is a flow chart illustrating a method for processing the NTSC video signal for display on the high definition matrix display in accordance with the present invention; and

FIG. 4 is a flow chart illustrating an alternative method for processing the NTSC video signal for display on the high definition matrix display in accordance with the present invention.

### DETAILED DESCRIPTION OF THE PREFERRED EMBODIMENT

The characteristics and advantages of the present invention will become more apparent from the following description, given by way of example.

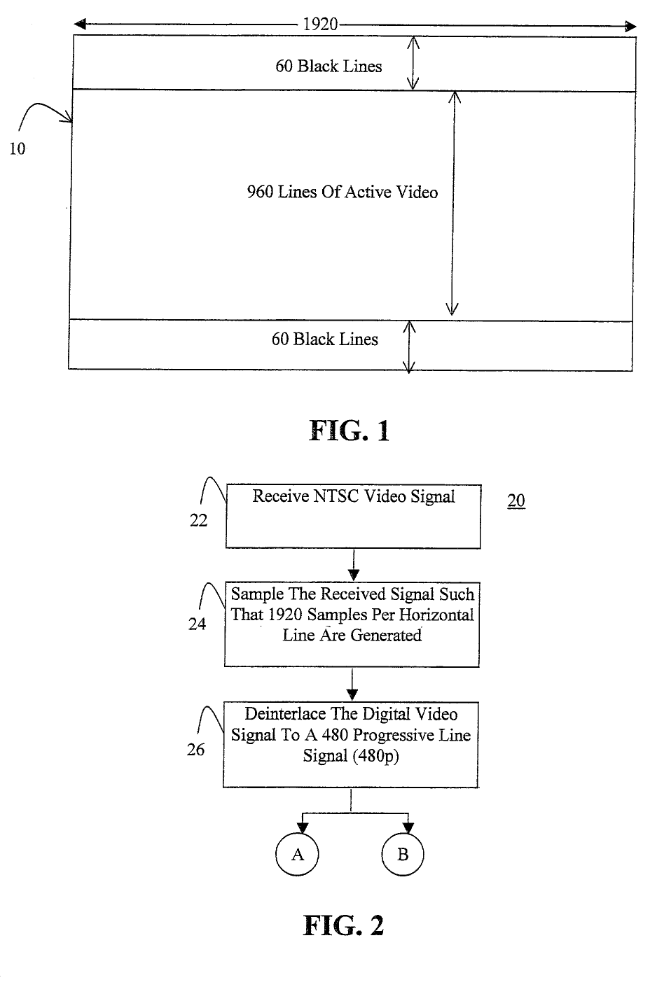

Referring to FIG. 1, an exemplary high definition matrix display 10 such as a 1920X1080 display is illustrated. The display preferably includes 1080 rows with each row having 1920 pixels. The top 60 rows and bottom 60 rows preferably display black pixels and the middle 960 rows display active video. The display is preferably a matrix display such as an LCD or LCOS display.

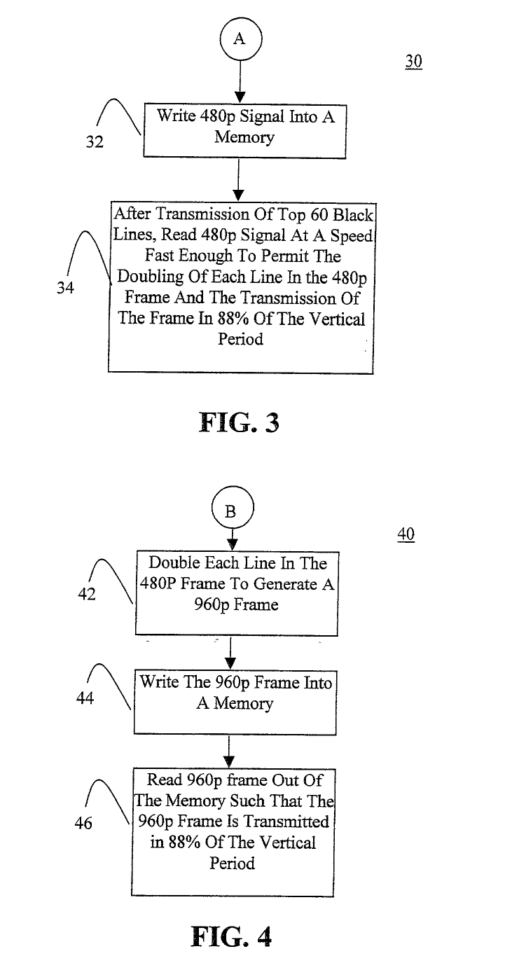

Referring now to FIG. 2, a method 20 is shown where a received NTSC video signal is received at block 22 and is preferably sampled at block 24 at a sampling frequency that produces 1920 samples per line (corresponding to the number of pixels on a row) or a sub-multiple thereof (e.g., 960). The resulting digital video is deinterlaced at block 26 to a progressive line signal such as a 480 progressive line signal or frame (480p). Afterwards, the 480p signal may be processed in accordance with processing method A (FIG. 3) or B (FIG. 4) such that the received NTSC signal can be displayed on the HDTV matrix display.

Referring now to the processing method 30 of FIG. 3, the progressive line signal or 480p signal is written into a memory at block 32. Afterwards, at block 34, black lines are transmitted for the top 60 lines of the display. Next, the memory is read out at a speed that is fast enough to get the stored lines out in a shortened vertical interval which is preferably at about 88% of the vertical interval. The vertical interval should be understood herein to mean the amount of time it takes to display all the rows of a high definition matrix display for a given progressive line signal. Since only 480 lines were stored, each line must be repeated and transmitted twice to produce the required 960 lines. The memory is utilized because the 960 lines are formed in a normal NTSC vertical active interval (i.e., 91.4% of the period).

Referring now to the alternative processing method 40 of FIG. 4, each line of the 480p signal is repeated (used twice) to form a signal corresponding to a predetermined number of active lines such as a 960p standard definition signal at block 42. The 960p signal is then written into a memory at block 44. Next, at block 46, the memory is read out at a speed that is fast enough to get the stored lines out at about 88% of the vertical interval. The shorter interval compensates for the transmission of black lines transmitted at the top and bottom of the display. The memory is utilized because the 960 lines are formed in a normal NTSC vertical active interval (i.e., 91.4% of the period).

It should be noted that the embodiments of FIGS. 3 and 4 do not necessarily require much processing in the display or special customization in a conventional high definition matrix display.

Although the present invention has been described in conjunction with the embodiments disclosed herein, it should be understood that the foregoing description is intended to illustrate and not limit the scope of the invention as defined by the claims.

What is claimed is:

1. A method of displaying a standard definition television signal on a high definition matrix display, comprising the steps of:
receiving the standard definition television signal to provide a received signal;
sampling the received signal to provide a sampled digital video signal;
deinterlacing the sampled digital video signal to provide a progressive line signal;
doubling the progressive line signal to provide a predetermined number of active lines of video in a frame; and
displaying the predetermined number of active lines of video on the high definition matrix display in a shortened vertical interval.

2. The method of claim 1, where the method further comprises the step of storing the progressive line signal into a memory before the step of doubling.

3. The method of claim 1, wherein the step of doubling comprises the step of reading each line of the progressive line signal twice from the memory to produce a standard 960p signal, wherein the progressive line signal is a 480p signal.

4. The method of claim 2, wherein the method further comprises the step of reading each line of the progressive line signal twice from the memory at a speed fast enough to produce the doubling of each line of the progressive line signal in the frame and to transmit the frame to the display in a shorter interval than was used to write the progressive line signal to the memory.

5. The method of claim 4, wherein the shorter interval compensates for the transmission of black lines transmitted at the top and bottom of the display.

6. The method of claim 1, wherein the method further comprises the steps of writing the signal corresponding to the predetermined number of active lines of video into a memory and reading out the predetermined number of active lines of video from the memory in a shorter time interval than was used to write the signal corresponding to the predetermined number of active lines of video into the memory.

7. The method of claim 6, wherein the signal corresponding to the predetermined number of active lines is a 960p frame which is read out of the memory and transmitted to the display in approximately 88% of a vertical period.

8. A method of displaying a standard definition television signal on a high definition matrix display, comprising the steps of:
receiving the standard definition television signal to provide a received signal;
sampling the received signal to provide a sampled digital video signal;
deinterlacing the sampled digital video signal to provide a progressive line signal;
doubling the progressive line signal to provide a predetermined number of active lines of video in a frame;
storing the frame containing the predetermined number of active lines in a memory; and
reading the frame from memory and transmitting it to the high definition matrix display in a shortened vertical interval.

9. The method of claim 8, wherein the shortened vertical interval is approximately 88% of a vertical interval.

10. The method of daim 8, wherein the step of doubling comprises the step of repeating each line of the progressive line signal to produce a standard 960p signal, wherein the progressive line signal is a 480p signal.

11. The method of claim 8, wherein step of storing the frame, comprises the step of storing a 960p signal into the memory.

12. The method of claim 8, wherein the shorter interval compensates for the transmission of black lines transmitted at the top and bottom of the display.

13. The method of claim 8, wherein the signal corresponding to the predetermined number of active lines is a 960p frame which is read out of the memory and transmitted to the display in approximately 88% of a vertical interval.
